(19) United States
(12) Patent Application Publication
(10) Pub. No.: US 2017/0055756 A1
(43) Pub. Date: Mar. 2, 2017

(54) APPARATUS AND METHOD FOR REMOVING NON-CONDENSABLE GASES FROM A STEAM GENERATOR

(71) Applicants: Lon LEHMAN, Ft. Wayne, IN (US); Eugene TIPPMANN, JR., Ft. Wayne, IN (US)

(72) Inventors: Lon LEHMAN, Ft. Wayne, IN (US); Eugene TIPPMANN, JR., Ft. Wayne, IN (US)

(21) Appl. No.: 15/256,257

(22) Filed: Sep. 2, 2016

Related U.S. Application Data
(60) Provisional application No. 62/213,472, filed on Sep. 2, 2015.

(51) Int. Cl. A47J 27/17

(52) U.S. Cl. CPC A47J 27/17

(57) ABSTRACT

An apparatus for removing non-condensable gases from a self-contained or closed loop steam generator. The apparatus is connected to an appliance, which includes the self-contained or closed loop steam generator. The apparatus may be configured to include a control system connected to various portions of the apparatus to provide for automatic removable of non-condensable gases from the steam generator. However, it should be understood that the apparatus can be operated manually. The removal of non-condensable gases occurs prior to generating steam for a cooking process with the apparatus attached directly to the appliance, or with the apparatus configured as a separate unit.

### CROSS-REFERENCE TO RELATED APPLICATIONS

This application claims the benefit of priority to U.S. Provisional Patent Application No. 62/213,472, filed on Sep. 2, 2015, which is hereby incorporated by reference in its entirety.

### TECHNICAL FIELD

This disclosure relates to appliances that include a steam generator.

### BACKGROUND

Self-contained or closed loop appliances using steam heat for commercial cooking are known. These appliances are used mainly to heat steam-jacketed kettles and griddles, some of which claim to be hermetically sealed, which would thus make these appliances self-contained or closed loop. Though such appliances are nominally self-contained or closed loop, such appliances have a reputation for not being hermetically sealed during manufacture, or for developing leaks during use in the field, which permits the intrusion of non-condensable gases, particularly when in a vacuum or negative pressure condition, or in an equalized or atmospheric pressure state. During a cooking process, these non-condensable gases inhibit the transfer of heat by the steam to the cooking surface, causing undesirable “cold spots” or “uneven” temperature zones. Non-condensable gases can also enter a steam generator during the manufacturing process. For example, non-condensable gases may be entrained in the liquid used to provide the steam, or by simply being in the reservoir and not adequately removed during the manufacturing process.

### SUMMARY

This disclosure provides an appliance, comprising a sealed reservoir, a temperature sensor, a gas handling circuit, and a processor. The sealed reservoir contains a fluid. The temperature sensor is positioned on the sealed reservoir to measure the temperature of the sealed reservoir. The gas handling circuit is connected to the sealed reservoir and includes a pump configured to pump air, an atmospheric inlet/outlet, and a valve. The valve is positioned along the gas handling circuit between the pump and the sealed reservoir and also between the pump and the atmospheric inlet/outlet. The valve is configured to connect the atmospheric inlet/outlet to the sealed reservoir in a first position and configured to disconnect the sealed reservoir from the atmospheric inlet/outlet in a second position. The processor is configured to receive a temperature signal from the temperature sensor. When the temperature signal indicates that the temperature of the sealed reservoir is less than a boiling temperature of the fluid, the processor transmits a signal to the valve to automatically control the valve to be in the first position. The processor then transmits a signal to the pump to operate until a predetermined condition is met. After the predetermined condition is met, the processor transmits a signal to the valve to control the valve to be in the second position.

Advantages and features of the embodiments of this disclosure will become more apparent from the following detailed description of exemplary embodiments when viewed in conjunction with the accompanying drawings.

### BRIEF DESCRIPTION OF THE DRAWINGS

FIG. 1 is a schematic view of an apparatus for removing non-condensable gases from a closed loop steam generator in accordance with an exemplary embodiment of the present disclosure.

FIG. 2 is process for removing non-condensable gases from a closed loop steam generator in accordance with an exemplary embodiment of the present disclosure.

### DETAILED DESCRIPTION

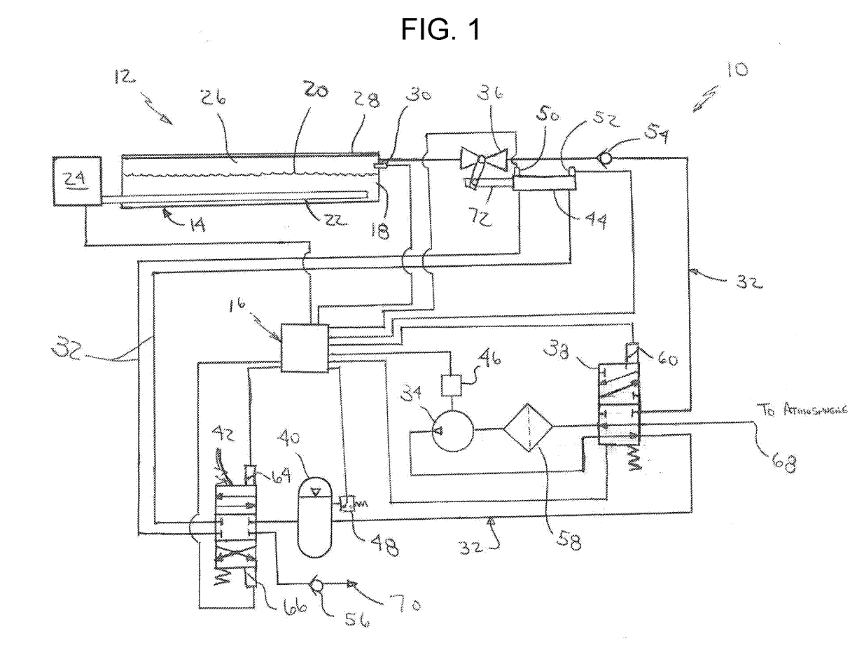

Referring to FIG. 1, a schematic view of an apparatus for removing non-condensable gases from a self-contained or closed loop steam generator in accordance with an exemplary embodiment of the present disclosure is shown, indicated generally at 10. Apparatus 10 is connected to an appliance 12, which includes a self-contained or closed loop steam generator 14. In the exemplary embodiment of FIG. 1, apparatus 10 includes a control system 16 connected to various portions of apparatus 10 to provide for automatic removable of non-condensable gases from self-contained or closed loop steam generator 14, which occurs prior to generating steam for a cooking process. However, it should be understood that apparatus 10 can be operated manually. Apparatus 10 can be attached directly to appliance 12, or apparatus 10 can be configured as a separate unit.

In addition to self-contained or closed loop steam generator 14, appliance 12 includes a reservoir 18 that is configured to contain a fluid 20, which is typically water. Appliance 12 further includes a submersed heating element 22 powered by a power supply or controller 24. When power supply or controller 24 is operated, power is provided to submersed heating element 22, which converts fluid 20 to a steam 26. Since reservoir 18 is self-contained and sealed, pressure is allowed to build in reservoir 18, causing steam 26 to become superheated. Appliance 12 also includes a cooking surface 28 positioned near, along, alongside, or adjacent to liquid/steam reservoir 18, in thermal communication with reservoir 18. Accordingly, heat from superheated steam 26 is transferred to cooking surface 28, which is then able to heat food to temperatures greater than 350 degrees Fahrenheit. Appliance 12 is further configured to include a temperature sensor or monitor 30.

Apparatus 10 is configured to include a plurality of devices positioned along an air handling circuit 32, including an air/vacuum pump 34, a steam generator ball valve 36, a pressure/vacuum valve 38, a reservoir 40, a cylinder control valve 42, and a bidirectional cylinder 44. Bidirectional cylinder 44 is configured to include an extendable and retractable piston 72. Apparatus 10 is also configured to include a drive motor 46 configured to drive pump 34, a pressure switch 48 configured to close when reservoir 40 is at a predetermined pressure level, an evacuate generator switch 50 configured to indicate when steam generator ball valve 36 is open to connect closed loop steam generator 14 to pump 34, and a close generator switch 52 configured to indicate when steam generator ball valve 36 is closed to prevent fluid, e.g., air, communication between closed loop steam generator 14 and pump 34. Apparatus 10 may also include a check valve 54 configured to prevent fluid or air flow from pressure/vacuum valve 38 toward closed loop steam generator 14, a check valve 56 configured to permit air flow from bidirectional cylinder 44 to atmosphere, and an air filter 58 configured to filter atmospheric air before it enters pump 34.

Pressure/vacuum valve 38 is further configured to include an actuation mechanism 60, which is operable to move pressure/vacuum valve 38 from a first position, as shown in FIG. 1, to a second position.

In the first position, pressure/vacuum valve 38 is configured to connect air from an atmospheric inlet/outlet 68, configured as a part of air handling circuit 32, to filter 58 and to an inlet of pump 34, and pressure/vacuum valve 38 is also configured to connect an outlet of pump 34 to reservoir 40.

In the second position, pressure/vacuum valve 38 is configured to connect the inlet of pump 34 to closed loop steam generator 14, and pressure/vacuum valve 38 is configured to connect the outlet of pump 34 to atmospheric inlet/outlet 68. Pressure/vacuum valve 38 may be biased, such as by a spring, to be in the first position, such that removal of power from actuation mechanism 60 permits pressure/vacuum valve 38 to return to the first position from the second position.

Cylinder control valve 42 is further configured to include actuation mechanisms 64 and 66, which are operable to move cylinder control valve 42 between a first, closed position, as shown in FIG. 1, a second position, and a third position. Cylinder control valve 42 may be biased to the first, closed position, such as by one or more springs.

In the second position, cylinder control valve 42 is configured to connect pressurized air from reservoir 40 to a first or right end of bi-directional cylinder 44, and is configured to connect relieved air from a second or left end of bi-directional cylinder 44 to an atmospheric outlet 70, which is configured as a part of air handling circuit 32, via check valve 56. In the second position, pressurized air flowing through cylinder control valve 42 flows into the right end of bi-directional cylinder 44, moving piston 72 into the extended position shown in FIG. 1, closing steam generator ball valve 36.

In the third position, cylinder control valve 42 is configured to connect pressurized air from reservoir 40 to the left end of bi-directional cylinder 44, and is configured to connect relieved air from the right end of bi-directional cylinder 44 to atmospheric outlet 70. In the third position, pressurized air flowing through cylinder control valve 42 flows into the left side of bi-directional cylinder 44, moving piston 72 into a retracted position (not shown), and closing steam generator ball valve 36.

Many aspects of the disclosure are described in terms of sequences of actions to be performed by elements of a computer system or other hardware capable of executing programmed instructions, for example, a general purpose computer, special purpose computer, workstation, or other programmable data processing apparatus. It will be recognized that in each of the embodiments including active or electronic elements, the various actions could be performed by specialized circuits (e.g., discrete logic gates interconnected to perform a specialized function), by program instructions (software), such as logical blocks, program modules etc. being executed by one or more processors (e.g., one or more microprocessors, a central processing unit (CPU), and/or application specific integrated circuit), or by a combination of both. For example, embodiments can be implemented in hardware, software, firmware, middleware, microcode, or any combination thereof. The instructions can be program code or code segments that perform necessary tasks and can be stored in a non-transitory, machine-readable medium such as a storage medium or other storage(s). A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents.

The non-transitory machine-readable medium can additionally be considered to be embodied within any tangible form of computer readable carrier, such as solid-state memory, magnetic disk, and optical disk containing an appropriate set of computer instructions, such as program modules, and data structures that would cause a processor to carry out the techniques described herein. A computer-readable medium may include the following: an electrical connection having one or more wires, magnetic disk storage, magnetic cassettes, magnetic tape or other magnetic storage devices, a portable computer diskette, a random access memory (RAM), a read-only memory (ROM), an erasable programmable read-only memory (e.g., EPROM, EEPROM, or Flash memory), or any other tangible medium capable of storing information.

It should be noted that the systems of the present disclosure are illustrated and discussed herein as having various modules and units which perform particular functions. It should be understood that these modules and units are merely schematically illustrated based on their function for clarity purposes, and do not necessarily represent specific hardware or software. In this regard, these modules, units and other components may be hardware and/or software implemented to substantially perform their particular functions explained herein. The various functions of the different components can be combined or segregated as hardware and/or software modules in any manner, and can be useful separately or in combination. Input/output or I/O devices or user interfaces including but not limited to keyboards, displays, pointing devices, and the like can be coupled to the system either directly or through intervening I/O controllers. Thus, the various aspects of the disclosure may be embodied in many different forms, and all such forms are contemplated to be within the scope of the disclosure.

Control system 16 is configured to include a CPU, processor, or controller, a non-transitory memory configured to contain instructions to operate one or more elements of apparatus 10, a display, an input, and may include one or more power supplies, amplifiers, wireless transceiver, receiver, and/or transmitter (not shown). Control system 16 is configured to include a wiring system 74 that permits signals to be transmitted by control system 16 to various elements of apparatus 10, and that permits signals to be transmitted by various elements of apparatus 10 to control system 16. Control system 16 is configured to be connected to power supply or controller 24, temperature sensor 30, drive motor 46, pressure switch 48, evacuate generator switch 50, close generator switch 52, actuation mechanism 60, actuation mechanism 64, actuation mechanism 66.

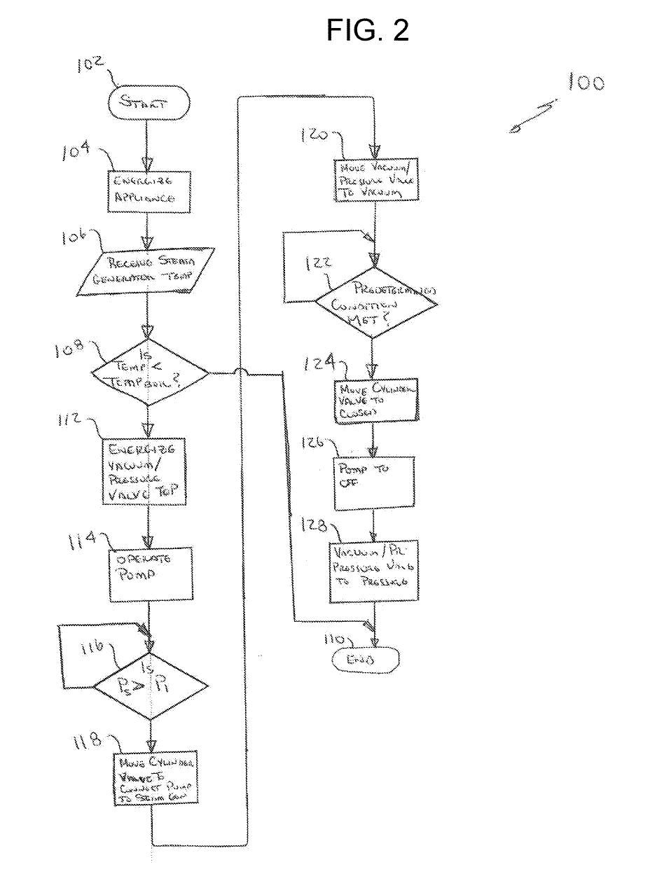

Apparatus 10 can operate by the non-condensable gas removal process shown in FIG. 2, indicated generally at 100. Process 100 begins with a start process 102, which may including verifying the amount of fluid 20 in reservoir 18, connecting power to apparatus 10, etc. Once start process 102 is complete, control passes to an energize appliance process 104.

In energize appliance process 104, appliance 12, which is shown as a self-contained griddle in FIG. 1, is energized via a control panel, on switch, or the like (not shown). Once appliance 12 is energized, and prior to entering a cooking process, control passes from energize appliance process 104 to a receive steam generator temperature process 106.

In receive steam generator temperature process 106, a signal representing a temperature of appliance 12 is transmitted from temperature sensor 30 to control system 16. Control then passes from receive steam generator temperature process 106 to a temperature level decision process 108.

In temperature level decision process 108, a determination of whether the temperature of appliance 12 is near or below a temperature that would cause fluid 20 to boil if placed under a vacuum by pump 34 is made. If the temperature of appliance 12 is above the temperature that would cause fluid 20 to boil when placed under a vacuum by pump 34, then control passes to an end process 110, which terminates non-condensable gas removal process 100. If the temperature is 12 is near or below a temperature that would cause fluid 20 to boil if placed under a vacuum by pump 34, then control passes from temperature level decision process 108 to pressure/vacuum valve process 112.

In pressure/vacuum valve process 112, control system 16 determines whether pressure/vacuum valve 38 is in the first position or the second position. If pressure/vacuum valve 38 is in the second position, power is removed from actuation mechanism 60 to permit pressure/vacuum valve 38 to move to the first position. Control then passes from pressure/vacuum valve process 112 to an operate pump process 114, where pump 34 is actuated by control system 16. Control then passes from operate pump process 114 to a pressure level decision process 116.

During operate pump process 114, pressure/vacuum valve 38 is in the first position to permit air flow along air handling circuit 32 from atmospheric inlet/outlet through pressure/vacuum valve 38 to pump 34. Pressurized air then flows from pump 34 along air handling circuit 32 through pressure/vacuum valve 38 to reservoir 40. Control then passes from operate pump process 114 to a pressure level decision process 116.

During pressure level decision process 116, reservoir 40 builds pressure until pressure in reservoir 40 is sufficient to actuate, activate, or operate pressure switch 48, which sends a signal to control system 16 that indicates to control system 16 that reservoir 40 has reached a predetermined pressure level. Once the predetermined pressure level is reached, control passes from pressure level decision process 116 to a cylinder valve actuation process 118. Note that in an exemplary embodiment, once reservoir 40 reaches the predetermined pressure level, control system 16 may command pump drive motor 46 to an off condition.

In cylinder valve actuation process 118, control system 16 transmits a signal to actuation mechanism 64 to move cylinder control valve 42 to the second position. In the second position, pressurized air flows along air handling circuit 32 from reservoir 40 through cylinder control valve 42 to the right end of bidirectional cylinder 44, extending piston 72, and opening steam generator ball valve 36. The opening of steam generator ball valve 36 is indicated by evacuate generator switch 50, though other devices, apparatus, or mechanisms can be used to indicate the position of bidirectional cylinder 44 and steam generator ball valve 36. Control then passes from cylinder valve actuation process 118 to a pressure/vacuum valve actuation process 120.

In pressure/vacuum valve actuation process 120, once evacuate generator switch 50 transmits a signal to control system 16 indicative of an open condition of steam generator ball valve 36, control system 16 transmits a signal to actuation mechanism 60 of pressure/vacuum valve 38, moving pressure/vacuum valve 38 from the first position to the second position. Once in the second position, control system 16 transmits a signal to pump drive motor 46 to operate, if pump drive motor 46 is off, which causes pump driver motor 46 to drive pump 34. Pump 34 then pulls air from reservoir 18 of appliance 12 by causing air to flow along air handling circuit 32 through steam generator ball valve 36, check valve 54, pressure/vacuum valve 38, and air filter 58 to pump 34. From pump 34, the air flows through pressure/vacuum valve 38 to atmospheric inlet/outlet 68. Control then passes from pressure/vacuum valve actuation process 120 to a predetermined condition process 122.

In predetermined condition process 122, a vacuum or negative pressure differential is pulled on reservoir 18 of appliance 12 by the action of pump 34. Pump 34 is operated for a time interval or period, which may or may not be adjustable and/or predetermined, or to a predetermined negative pressure differential, which may or may not be adjustable and monitor by a vacuum/pressure switch (not shown) in order to remove non-condensable gases from closed loop steam generator 14. When time expires, the interval ends, or the desired negative pressure differential is achieved, i.e., when a predetermined condition is met, control passes from predetermined condition process 122 to a cylinder valve closed process 124.

In cylinder valve closed process 124, control system 16 removes the actuation signal from actuation mechanism 64, and transmits an actuation signal to actuation mechanism 66, which causes cylinder control valve 42 to move from the second position to the third position. In the third position, pressurized air from reservoir 40 flows along air handling circuit 32 through cylinder control valve 42 to the left end of bidirectional cylinder 44, causing piston 72 to retract, which causes steam generator ball valve 36 to move from an open position to a closed position, which is indicated by a signal transmitted from close generator switch 52 to control system 16. Control then passes from cylinder valve closed process 124 to a pump off process 126, where control system 16 transmits a signal to pump drive motor 46 to turn off, stopping the operation of pump 34. Control then passes from pump off process 126 to a pressure/valve to pressure side process 128.

In pressure/valve to pressure side process 128, control system 16 removes the actuation signal from pressure/vacuum valve 38, which permits pressure/vacuum valve 38 to move from the second position to the first position. Appliance 12 is now ready for operation.

As previously noted, check valves 54 and 56 may or may not be used. Also, a lockout circuit may or may not be used to keep appliance 12 from being operational if evacuate generator switch 50 is in the open state.

While various embodiments of the disclosure have been shown and described, it is understood that these embodiments are not limited thereto. The embodiments may be changed, modified, and further applied by those skilled in the art. Therefore, these embodiments are not limited to the detail shown and described previously, but also include all such changes and modifications.

I/We claim:

1. An appliance, comprising:
a sealed reservoir containing a fluid;
a temperature sensor positioned on the sealed reservoir to measure the temperature of the sealed reservoir;
a gas handling circuit connected to the sealed reservoir, the gas handling circuit including
a pump configured to pump air,
an atmospheric inlet/outlet, and
a valve positioned along the gas handling circuit between the pump and the sealed reservoir and also between the pump and the atmospheric inlet/outlet, the valve configured to connect the atmospheric inlet/outlet to the sealed reservoir in a first position and configured to disconnect the sealed reservoir from the atmospheric inlet/outlet in a second position; and
a processor configured to receive a temperature signal from the temperature sensor, and when the temperature signal indicates the temperature of the sealed reservoir is less than a boiling temperature of the fluid, the processor transmits a signal to the valve to automatically control the valve to be in the first position, the processor then transmits a signal to the pump to operate until a predetermined condition is met, and after the predetermined condition is met, the processor transmits a signal to the valve to control the valve to be in the second position.
